(19) United States
(12) Patent Application Publication
(10) Pub. No.: US 2008/0093389 A1
(43) Pub. Date: Apr. 24, 2008

(54) Pump Including Means Of Air Exhaust

(76) Inventors: Matthieu Vasseur, Varengeville-Sur-Mer (FR); Christophe Roy, Dieppe (FR)

Correspondence Address: ST. ONGE STEWARD JOHNSTON & REENS, LLC, 986 BEDFORD STREET, STAMFORD, CT, 06905-5619, US

(21) Appl. No.: 11/875,293

(22) Filed: Oct. 19, 2007

(30) Foreign Application Priority Data
Oct. 20, 2006 (FR) 06 09247

(51) Int. Cl. G01F 11/00

(52) U.S. Cl. 222/321.9

(57) ABSTRACT

The invention relates to a pump intended to be mounted on a vial in such a way as to allow the distribution of a liquid contained in said vial, wherein the internal surface of body incorporates means of air exhaust that are arranged to, in a portion of the compression stroke, break the friction contact of piston on said surface in such a way as to allow air to escape from the dosing chamber to the exterior of body.

### CROSS-REFERENCE TO RELATED APPLICATIONS

The present application claims priority of French patent application No. 06 09247 filed on Oct. 20, 2006, the content of which is incorporated herein by reference.

### FIELD OF THE INVENTION

The invention relates to a pump intended to be mounted on a vial in such a way as to allow the distribution of a liquid contained in said vial.

### BACKGROUND OF THE INVENTION

In a particular application, the liquid is of the gel or cream type, for example for use in cosmetics or for pharmaceutical treatments.

According to their behavior and characteristics, the liquids are sometimes difficult to withdraw from the vial using a pump. In particular, when the viscosity and/or density of the liquid is high, the pump will have difficulties in sucking the liquid.

In this case, the priming of the pump is also a problem since this phase requires prior aspiration of air that, being compressible contrary to the liquid to be distributed, does not make it possible to obtain a suction force that is sufficient to fill the pump with the liquid.

Likewise, there is a problem of priming pumps that are equipped with a means of sealing the dispensing path, said means of sealing allowing in particular to reduce the drying of the liquid in the dispensing path. Indeed, during the priming phase, the means of sealing constitutes an obstacle to the circulation of the air in the dispensing path, said obstacle being difficult for the air compressed in the pump to cross.

### SUMMARY OF THE INVENTION

The purpose of the invention is to solve the problems of the prior art by proposing in particular a pump which has a strong air suction capacity in the priming phase.

To that effect, the invention proposes a pump intended to be mounted on a vial in such a way as to allow the distribution of a liquid contained in said vial, said pump comprising:

a pump body intended to be attached to the vial and being able to be placed in communication with the liquid;

an injector attached to a push button to be activated in translation in said body, said injector comprising a dispensing path comprising at least one upstream orifice and a channel of which the downstream end is in communication with a dispensing nozzle;

an elastic return means for the translation of said injector in said body;

a piston mounted in friction contact against the internal surface of said body in such a way as to delimit a dosing chamber that is intended to be in communication with the liquid by the intermediary of a valve, said piston being moved in translation by the injector on a compression stroke of the dosing chamber, said piston being arranged to seal the upstream orifices on the compression stroke and, on a distribution stroke of said injector, in order to allow the communication of the upstream orifices with the dosing chamber;

said pump being characterized in that the internal surface of the body incorporates means of air exhaust that are arranged to, in a portion of the compression stroke, break the friction contact of the piston on said surface in such a way as to allow air to escape from the dosing chamber to the exterior of the body.

### BRIEF DESCRIPTION OF THE DRAWINGS

Other purposes and advantages of the invention shall appear in the disclosure that follows in reference to the annexed figures, wherein:

FIGS. 1a and 1b are partial longitudinal cross-sections of a pump according to a mode for carrying out the invention, respectively in idle position (1a) and at the end of the compression stroke (1b);

FIG. 1c is an enlarged view of the encircled portion referenced as C in FIG. 1b;

FIG. 2a is a perspective view of the bottom of a pump body according to a first alternative of FIG. 1;

FIG. 2b is a partial cross-section view showing the profile of the internal surface of the body of FIG. 2a on the encircled portion referenced as B;

FIGS. 3a and 3b are analogous views respectively to FIGS. 2a and 2b for a pump according to a second alternative of FIG. 1.

### DETAILED DESCRIPTION OF THE INVENTION

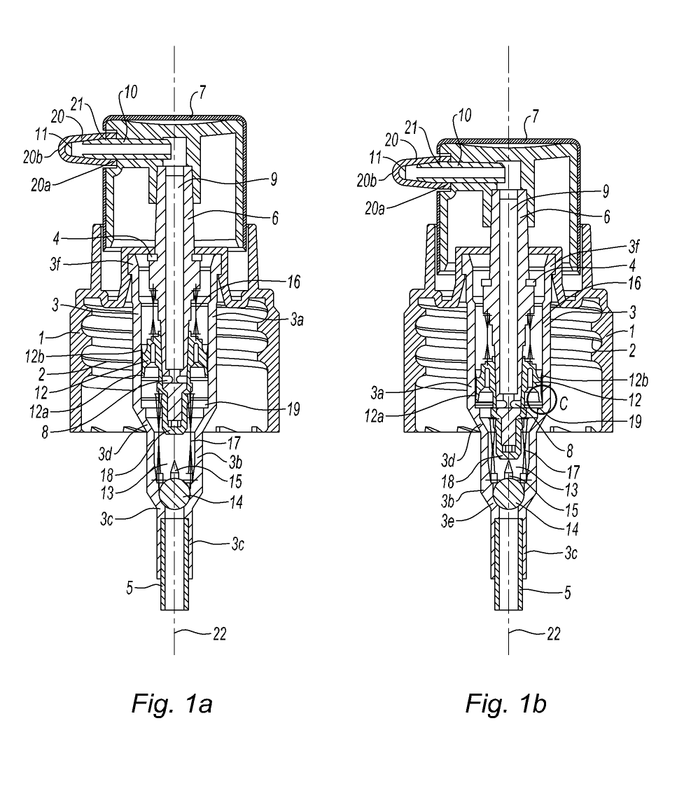

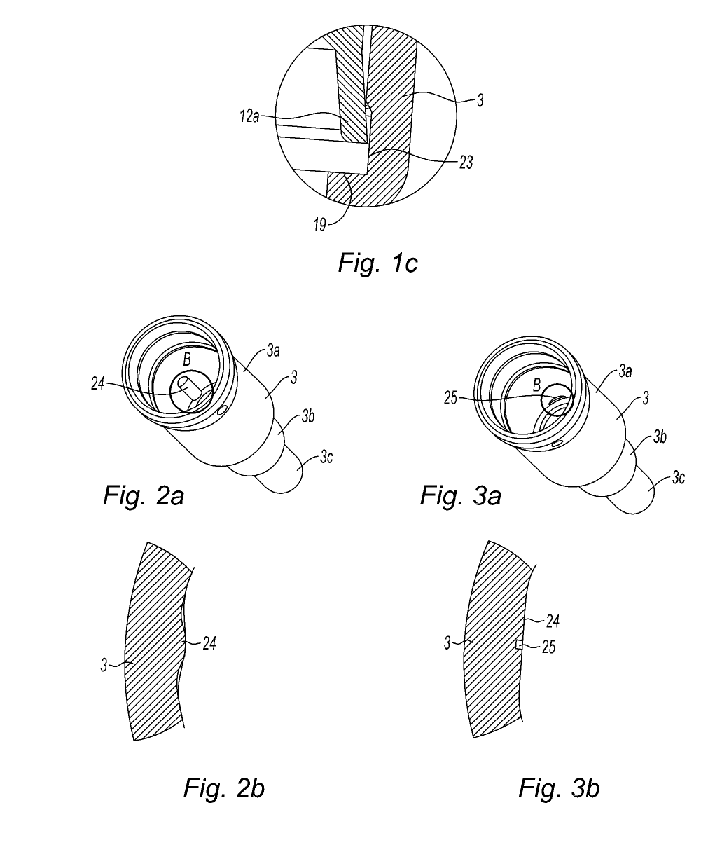

In the disclosure, the terms of positioning space are taken in reference to the position of the pump shown in FIG. 1.

In relation with the figures, hereinbelow described is a pump intended to be mounted on a vial (not shown) in such a way as to allow the distribution of a liquid contained in said vial. In an example, the liquid is a gel or a cream, for a cosmetic use or for pharmaceutical treatments.

The pump includes an association cup 1 on the vial, said cup having interior threading 2 that is intended to cooperate with a complementary threading provided on the ring of the vial. In other embodiments, cup 1 can include a geometry and/or configurations of means of association on the vial that are different.

The pump also includes a pump body 3 that is attached to the cup, said body having a cylindrical-conical geometry that is delimited by an interior surface. More particularly, body 3 functionally includes three cylinder sections 3a, 3b, 3c of different diameters that are connected to each other by two conical frustums 3d, 3e, and an upper snap-lock groove 3f on cup 1. Furthermore, an internal seal 4 is provided between body 3 and cup 1.

The pump includes a third element attached to the vial, a plunger tube 5 whose upper portion is fitted in the lower section 3c and whose lower portion is immersed in the liquid contained in the vial.

Moreover, the pump includes an injector 6 which is placed in body 3. Injector 6 is attached to a push button 7 which can be activated by the user in such a way as to move said injector in said body.

Injector 6 includes a substantially vertical dispensing path which is formed of two upstream radial orifices 8 and a channel 9 in communication with said orifices. Moreover, the downstream end of channel 9 is inserted in push button 7 in order to be in communication with a dispensing nozzle 10 by the intermediary of a pathway provided in said button. As shall be seen in more detail in the rest of the disclosure, nozzle 10 is incorporated into push button 7 to be able to distribute the liquid through a distribution orifice 11.

The pump also includes a piston 12 which is mounted in friction contact against the internal surface of body 3, and more particularly against the internal surface of upper section 3a. Piston 12 delimits a dosing chamber 13 that is provided in the intermediary section 3b, said chamber being in communication with plunger tube 5 by the intermediary of a valve formed of a ball 14 placed on the lower conical frustum 3e. Conical frustum 3e is equipped with retaining tabs 15 of the ball 14 in such a way as to form a retention cage of the latter at the bottom of the dosing chamber 13.

Piston 12 is mounted around injector 6 in a sliding manner, said sliding being constrained by an elastic return means formed of a preloaded spring 16. For that, the upper coil of spring 16 is supported by a seat of injector 6, and the lower coil is supported by piston 12.

Moreover, the pump is equipped with an elastic return spring 17 for the translation of injector 6 in body 3. This spring 17 is provided in the dosing chamber 13 respectively supported in the bottom of the latter and on a thrust bearing 18 attached to the lower end of injector 6.

Hereinbelow is described the operation of such a pump after the priming phase thereof. Starting from idle position (FIG. 1a), when the user presses button 7, the latter causes the translation of injector 6 on a said compression stroke of dosing chamber 13. Indeed, on this stroke, since piston 12 is attached to injector 6, it compresses the volume of said dosing chamber. Moreover, still on this stroke, piston 12 is arranged to seal upstream orifices 8 in such a way as to provide compression by closing the dispensing path.

At the end of the compression stroke (FIG. 1b), piston 12 is supported on thrust bearing 19 formed on the internal surface of body 3, in such a way as to prevent the translation of said piston together with said body.

Beyond this compression stroke, immobilized piston 12 slides on injector 6 in such a way as to allow communication of upstream orifices 8 with dosing chamber 13 on said distribution stroke.

As such, with dosing chamber 13 under pressure, a rise of liquid in the dispensing path follows on the distribution stroke, and therefore a distribution of said liquid through nozzle 10.

Then, when injector 6 rises back, the latter sucks the liquid in dosing chamber 13 by the intermediary of plunger tube 5 and causes ball 14 forming the valve to be lifted.

Although the disclosure is done in relation with a pump presenting a particular arrangement and cinematic relative to the distribution of the fluid, the invention is not limited to this embodiment. In particular, pumps are known wherein, instead of being moved over the distribution stroke, the piston is deformed in order to open communication between the upstream orifices and the dosing chamber. Pumps are also known that do not include a preloaded spring. Furthermore, pumps without cups are also known, for example comprising a part forming a cap which is inserted into the ring of the vial.

During the priming phase, dosing chamber 13 contains primarily air that is compressed on the compression stroke. Then, the opening of the upstream orifices 8 introduces the compressed air in the dispensing path without however, in certain cases, presenting enough pressure in order to be able to be evacuated by the intermediary of nozzle 10.

In particular, this situation occurs for dense and/or viscous liquids, as well as with nozzles 10 comprising a means of sealing the dispensing path, such as described hereinbelow in relation with FIG. 1.

Indeed, in such a nozzle 10, which is particularly useful to decrease the drying of the liquid in the dispensing path, the means of sealing constitutes an obstacle to the circulation of the air in the dispensing path, said obstacle being difficult for the air compressed in dosing chamber 13 to cross.

On the contrary, since the liquid cannot be compressed, the application of the distribution pressure of said fluid allows the means of sealing to be deactivated in such a way as to allow it to be distributed through nozzle 10.

In the embodiment shown, the means of sealing includes a rubber tubular sleeve 20 that is associated, for example by being attached (FIG. 1) or by non-adherent over-moulding, on a rigid part 21 equipped with the distribution orifice 11.

Sleeve 20 includes an open rear flange 20a that is engaged in a groove of the rigid body in such a way as to provide an anchoring of said sleeve on said body and thus avoid ejection thereof during distribution. Sleeve 20 also includes a front blank 20b that is arranged to open in a reversible manner under the effect of the distribution pressure so as to allow the liquid coming from orifice 11 to pass through it.

According to the invention, the internal surface of body 3 incorporates means of air exhaust that are arranged to, in a portion of the compression stroke, break the friction contact of piston 12 on said surface in such a way as to allow air to escape from the dosing chamber 13 to the exterior of body 3. As such, the air compressed during the priming phase is not evacuated by the dispensing path which can have an excessive load loss, but directly on the exterior of the pump. This results in an increase in the suction force of the liquid when injector 3 rises back, and therefore an optimization of the priming phase.

According to the embodiment shown, the means of air exhaust are placed on the junction between the compressions and distribution strokes, more precisely in the portion of the internal surface which is positioned just above thrust bearing 19 (see encircled zone referenced as C in FIG. 1b).

Hereinbelow are described three embodiments of the means of air exhaust that can be considered with a piston 12 comprising a lower sealing lip 12a which is in friction contact on the internal surface of body 3. Lip 12a is annular and extends in the direction of dosing chamber 13 by moving away from axis 22 of translation of injector 3. Moreover, the support of piston 12 on thrust bearing 19 is provided by the intermediary of said lower lip.

Piston 12 further comprises an upper sealing lip 12b which is in friction contact on the internal surface of body 3, said upper lip extending across from lower lip 12a in relation to the direction of translation of injector 3.

The means of air exhaust described are arranged in order to allow the detaching of lower lip 12a during the passage on said means thereof. In particular, sealing lip 12a is made from a semi-rigid elastic material in such a way as to limit its ability to hug the form of the means of air exhaust, thus creating a punctual leakage of air through the loss of the seal.

However, the dimension of the means of air exhaust is sufficiently small to substantially prevent the passage of the liquid during detaching, in such a way as to not degrade the distribution performance of the liquid. In any case, the presence of upper lip 12b limits possible leaks of liquid beyond piston 12.

According to the embodiment of FIG. 1, the means of air exhaust are formed of a zone 23 of greater diameter than the nominal diameter of section 3a. Indeed, during the passage of lower lip 12a on the junction with zone 23 of greater diameter (FIG. 1c), the seal between said lip and body 3 is broken. In the embodiment shown, zone 23 extends until thrust bearing 19 over a height such that the seal is reformed during the support of said lower lip on said thrust bearing.

According to the embodiments of FIGS. 2 and 3, the means of air exhaust are formed of a lobe 24, however more than one lobe could also be considered, in particular several lobes distributed on the circumference of body 3.

According to the embodiment of FIG. 3, the lobe includes a flow-through channel 25 of which the dimension is arranged so that said channel is not sealed during the passage of lip 12a thereon. In particular, flow-through channel 25 extends along the axis of translation 22 of injector 6.

1. Pump intended to be mounted on a vial so as to allow the distribution of a liquid contained in said vial, said pump comprising:
a pump body intended to be attached to the vial and able to be placed in communication with the liquid;
an injector attached to a push button to be activated in translation in said body, said injector comprising a dispensing path comprising at least one upstream orifice and a channel of which the downstream end is in communication with a dispensing nozzle;
an elastic return means for the translation of said injector in said body;
a piston mounted in friction contact against the internal surface of said body in such a way as to delimit a dosing chamber that is intended to be in communication with the liquid by the intermediary of a valve, said piston being moved in translation by injector on a compression stroke of the dosing chamber, said piston being arranged to seal the upstream orifices on the compression stroke and, on a distribution stroke of said injector, in order to allow the communication of the upstream orifice with the dosing chamber;
said pump being characterized in that the internal surface of body incorporates means of air exhaust that are arranged to, in a portion of the compression stroke, break the friction contact of piston on said surface in such a way as to allow air to escape from the dosing chamber to the exterior of body.

2. Pump according to claim 1, characterized in that the means of air exhaust are placed on the junction between the compression and distribution strokes.

3. Pump according to claim 1, characterized in that piston includes a lower sealing lip that is in friction contact on the internal surface of body.

4. Pump according to claim 3, characterized in that the lower lip extends in the direction of dosing chamber by moving away from the axis of translation of injector.

5. Pump according to claim 3, characterized in that piston includes an upper sealing lip that is in friction contact on the internal surface of body, said upper lip extending across from lower lip in relation to the direction of translation of injector.

6. Pump according to claim 3, characterized in that the means of air exhaust are arranged in order to allow detaching of the lower lip during the passage on said means thereof.

7. Pump according to claim 6, characterized in that the means of air exhaust are formed by a zone of greater diameter.

8. Pump according to claim 6, characterized in that the means of air exhaust are formed of at least one lobe 24.

9. Pump according to claim 8, characterized in that lobe includes a flow-through channel of which the dimension is arranged so that said channel is not sealed during the passage of lower lip thereon.

10. Pump according to claim 9, characterized in that channel extends along axis of translation of the injector.

11. Pump according to claim 1, characterized in that nozzle is equipped with means of sealing the dispensing path, said means able to be deactivated by application of the distribution pressure of the liquid.

12. Pump according to claim 11, characterized in that the means of sealing includes a rubber sleeve which is associated to a rigid part equipped with a distribution orifice, said sleeve being arranged to seal said orifice in a reversible manner.

13. Pump according to claim 12, characterized in that sleeve includes a rear flange that is engaged in a groove of rigid body, and a front blank that is arranged to open in a reversible manner under the effect of the distribution pressure so as to allow the liquid to pass through it.

14. Pump according to claim 2, characterized in that piston includes a lower sealing lip that is in friction contact on the internal surface of body.

15. Pump according to claim 4, characterized in that piston includes an upper sealing lip that is in friction contact on the internal surface of body, said upper lip extending across from lower lip in relation to the direction of translation of injector.
